(19) United States
(12) Patent Application Publication
(10) Pub. No.: US 2026/0120267 A1
(43) Pub. Date: Apr. 30, 2026

(54) METHOD AND SYSTEM FOR TRAINING A VISUAL INSPECTION MODEL

(71) Applicant: LG MANAGEMENT DEVELOPMENT INSTITUTE CO., LTD., Seoul (KR)

(72) Inventors: Run CUI, Seoul (KR); Seung Hwan KIM, Seongnam-si (KR); Jee Ho HYUN, Incheon (KR); Gi Young JEON, Seoul (KR); Dong Hun LEE, Seoul (KR); Byung Jun KANG, Yongin-si (KR); Sang Yun KIM, Gimpo-si (KR); Young San KOH, Seoul (KR)

(21) Appl. No.: 19/420,629

(22) Filed: Dec. 15, 2025

Related U.S. Application Data
(63) Continuation of application No. PCT/KR2025/003425, filed on Mar. 17, 2025.

(30) Foreign Application Priority Data
Mar. 29, 2024 (KR) 10-2024-0043202

(51) Int. Cl. G06T 7/00; G06N 20/00; G06V 10/764

(52) U.S. Cl. CPC G06T 7/0008; G06N 20/00; G06V 10/764; G06T 2207/30164

(57) ABSTRACT

A visual inspection method, computing system and computing device are provided. An exemplary method includes providing a uniform group of manufactured products, performing a first process for detecting noisy label data within a training data set, acquiring a noisy data set and a clean data set according to the noisy label data detected based on the first process, performing a second process for training a vision inspection model based on the acquired noisy data set and clean data set, visually inspecting the products using the vision inspection model to identify defective products within the group, and removing the defective products from the group. The two stage vision inspection model training method and system prevents performance degradation due to mislabeled training data, maintains maximum recall on defective data, and improves precision for good product data.

### CROSS REFERENCE TO RELATED APPLICATION

This application is a Bypass Continuation of International Patent Application No. PCT/KR2025/003425, filed on Mar. 17, 2025, which claims priority from and the benefit of Korean Patent Application No. 10-2024-0043202, filed on Mar. 29, 2024, which is hereby incorporated by reference for all purposes as if fully set forth herein.

### BACKGROUND

### Field

Embodiments of the invention relate generally to a vision inspection model training method and system thereof, and, more particularly, the present disclosure relates to a 2-stage vision inspection model training method and system thereof, which separately trains a first stage process for detecting noisy label data and a second stage process for training a classification model using learning policies optimized for each purpose, in order to efficiently make use of a data set containing noisy labels.

### Discussion of the Background

Vision inspection uses machine learning methods such as classification or detection to automate the recognition of potential defects that occur on an appearance of a product. Ultimately, the presence/absence of defects (OK/NG) is classified, and the accuracy of the classification is important for preventing the leakage of defective products.

These machine learning methods require a training data set constructed through a labeling work process, whereby humans review collected image data, discriminate the presence/absence of defects, and manually pair correct answers with the data.

In order to secure the diversity of image patterns that is required to achieve high confidence in visual inspection results, including image patterns that have been influenced by various environmental factors, a large amount of training data is required. However, because humans conventionally needed to label such a large amount of data, workers have been prone to error due to decreased concentration, and the quality of the resulting training data sets has suffered from differences in defect discrimination skills among the workers and ambiguity in the discrimination criteria. This has led to a high probability of mislabeled data being included in the training data sets.

This noisy label issue even occurs in widely used public datasets in the field of computer vision, such as MNIST, CIFAR-10, and/or ImageNet.

While many studies have proposed approaches that enable robust learning on datasets containing noisy labels through technical approaches such as sample selection and/or loss regularization, most studies aim to improve performance based on classification accuracy evaluation indices on common public datasets like CIFAR-100.

Accordingly, existing studies have shown that even when the accuracy level is lowered (prevalence of defects is increased), high classification accuracy on good products may lead to improved evaluation index results.

However, in the field of vision inspection, the goal is to prevent the leaking (passing) of defective products as much as possible. Accordingly, unlike in results shown by previous studies, the goal of future studies should be to improve precision on good product data while maintaining maximum recall on defective data.

To address this need in the field of vision inspection, better model training is essential for achieving high-performance classification accuracy. However, such technological development has been lacking to date.

Existing technologies approach the detection of noisy label data and the training of a classification model simultaneously.

Noisy label data detection is advantageous in that it selects noisy labels through the distribution of true labels within clusters with similar feature patterns in a widely distributed feature pattern space centered on image texture. However, this learning policy for noisy label data detection degrades the performance of classification model training, which learns feature patterns centered on ground truth labels to better distinguish classes.

In other words, conventional approach methods, such as in Related Art 1 (C. Feng, et al., SSR: An Efficient and Robust Framework for Learning with Unknown Label Noise, arXiv: 2111.11288 [cs.CV] (2022)) that simultaneously detect noisy label data and train a classification model, suffer from the issue of degraded classification performance due to learning policies that are limited by conflict between feature learning for the noisy label data detection and classification learning focused on class distinction. (SSR is an acronym for Sample Selection and Relabeling.) Furthermore, feature learning, based on negative cosine similarity, considers only feature variations within the subject sample without considering other samples, resulting in poor performance for vision inspection data with simple patterns.

Conventional methods, such as in Related Art 2 (G. Pleiss, et al., Identifying Mislabeled Data using the Area Under the Margin Ranking, arXiv: 2001.10528 [cs.LG] (2020)), use the feature that learning convergence occurs on accurately labeled, easy samples in the early learning stage, and on noisy label samples in the later learning stage. This method proposes detecting noisy label samples based on the difference in loss between epochs.

However, these conventional methods have difficulty in determining a noisy label sample because the determination will vary depending upon the point in time of epoch of learning, and the epoch criterion varies greatly depending on the data.

In addition, contrastive learning and a variation learning method of a supervised learning method derived therefrom have brought significant advancements to the field of image classification.

Herein, the contrastive learning refers to a learning method that reduces the distance between similar image samples in a feature space and increases the distance between dissimilar image samples.

In particular, supervised learning-based contrastive learning utilizes class information to bring feature vectors within the same class closer together in the feature space while moving feature vectors between different classes further apart, thereby improving discriminability between classes.

Contrastive learning not only improves the classification accuracy of a model but also induces the model to be trained robustly despite various variations to input, and thus is a learning method that is strong in tasks such as industrial defect detection that requires high precision.

However, as described above, the noisy label data not only significantly reduces the effectiveness of the aforementioned contrastive learning, but also acts as a factor that interferes with learning during classification learning, thereby lowering the overall model performance.

Accordingly, there is a need in the art for the development and introduction of new technologies capable of resolving the aforementioned issues.

The above information disclosed in this Background section is only for understanding of the background of the inventive concepts, and, therefore, it may contain information that does not constitute prior art.

### SUMMARY

An embodiment of the present disclosure is directed to providing a 2-stage vision inspection model training method and system thereof, which separately trains a first stage process for detecting noisy label data and a second stage process for training a classification model using learning policies optimized for each purpose, in order to efficiently learn a data set containing noisy labels.

However, the technical tasks of an embodiment of the present disclosure are not limited to those as described above, and other technical tasks may exist.

A vision inspection model training method according to an embodiment of the present disclosure pertains to a method for a computing system and may include a memory and a processor to train a vision inspection model, wherein the method may include performing a first process for detecting noisy label data within a training data set acquiring a noisy data set and a clean data set according to the noisy label data detected based on the first process, and performing a second process for training the vision inspection model based on the acquired noisy data set and clean data set.

In another embodiment, a visual inspection method may comprise providing a uniform group of manufactured products, performing a first process for detecting noisy label data within a training data set, acquiring a noisy data set and a clean data set according to the noisy label data detected based on the first process, performing a second process for training a vision inspection model based on the acquired noisy data set and clean data set, visually inspecting the products using the vision inspection model to identify defective products within the group, and removing the defective products from the group.

The vision inspection model may include at least one encoder, at least one adaptation layer, at least one projection head, and at least one classifier.

The performance of the first process may include initializing the vision inspection model, performing a first warm-up training to train the initialized vision inspection model for a predetermined number of epochs based on the training data set, detecting the noisy label data within the training data set based on the vision inspection model trained with the first warm-up training, acquiring a random clean data set according to the detected noisy label data, performing noisy label detection learning to train the vision inspection model trained with the first warm-up training for a predetermined number of epochs based on the acquired random clean data set and the training data set, detecting the noisy label data within the training data set based on the noisy label detection trained vision inspection model and acquiring the noisy data set and the clean data set according to the detected noisy label data.

The performance of the first warm-up training may include performing learning based on cross entropy loss.

The performance of the first warm-up training may further include extracting a predetermined data pair from the training data set; performing data augmentation based on the extracted data pair; and acquiring weak variation augmentation data, which is data with relatively small variations, and strong variation augmentation data, which is data with relatively large variations, based on the performed data augmentation.

The performance of the first warm-up training may further include acquiring first mix-up data, which is data obtained by mixing up first weak variation augmentation data and second weak variation augmentation data, and second mix-up data, which is data obtained by mixing up first weak variation augmentation data and first strong variation augmentation data.

The performance of the first warm-up training may further include performing learning according to the cross entropy loss based on the first mix-up data, the second mix-up data, and the first strong variation augmentation data.

The detection of the noisy label data may include computing cosine similarity between other training data based on first training data within the training data set, extracting a predetermined number (k) of neighboring training data, which is other training data with high computed cosine similarity, computing voting scores for each of the extracted neighboring training data and detecting the noisy label data based on the computed voting scores.

The performance of the noisy label detection learning may include training the projection head based on a first clean data set and a contrastive loss and training the encoder, the adaptation layer, and the classifier based on the training data set and the cross entropy loss.

The performance of the noisy label detection learning may include detecting an original data set corresponding to the first clean data set, performing data augmentation based on the detected original data set and performing the noisy label detection learning based on the augmented data.

The performance of the second process may include newly initializing the vision inspection model, performing a second warm-up training to train the newly initialized vision inspection model for a predetermined number of epochs based on the clean data set and performing a high-performance classification model training to train the vision inspection model trained with the second warm-up training for a predetermined number of epochs based on the clean data set and the noisy data set.

The performance of the high-performance classification model training may include performing learning according to concurrent use of cross entropy loss and supervised learning-based contrastive loss based on the clean data set and performing learning according to contrastive loss based on the noisy data set.

The vision inspection model training method may further include providing the vision inspection model trained based on the second process through a predetermined application service.

In another embodiment, a computing system may comprise a non-transitory memory and at least one processor, the memory including instructions to provide a vision inspection service using a multi-tasking model, the model being trained and implemented according to a method that may comprise providing a manufactured product, receiving an inspection target image of the product from a user computing device, performing a first process for detecting noisy label data within a training data set, acquiring a noisy data set and a clean data set according to the noisy label data detected based on the first process, performing a second process for training the multi-tasking model based on the acquired noisy data set and clean data set, inputting the received inspection target image into the trained multi-tasking model to generate a classification result for the image and transmitting the generated classification result to the user computing device.

In the computing system, the classification result may comprise at least one of information indicating whether the inspection target image is normal or defective, information on a type of defect, or a confidence score.

In the computing system, the user computing device may visually highlight and display a location of the defect on the inspection target image based on the transmitted classification result.

A vision inspection model training system according to an embodiment of the present disclosure may include at least one memory and at least one processor for training a vision inspection model by reading at least one application stored in the memory, wherein instructions of the processor may include instructions for performing a first process for detecting noisy label data within a training data set, acquiring a noisy data set and a clean data set according to the noisy label data detected based on the first process; and performing a second process for training the vision inspection model based on the acquired noisy data set and clean data set.

A computing device according to an embodiment of the present disclosure may include at least one encoder; at least one adaptation layer; at least one projection head; at least one classifier; and at least one processor controlling the encoder, the adaptation layer, the projection head, and the classifier, wherein the processor may be configured to perform a first process for detecting noisy label data within a training data set, acquire a noisy data set and a clean data set according to the noisy label data detected based on the first process and perform a second process for training a vision inspection model based on the acquired noisy data set and clean data set.

A vision inspection model training method and system thereof according to an embodiment of the present disclosure provides a 2-stage vision inspection model training method and system thereof, which separately trains a first stage process for detecting noisy label data and a second stage process for training a classification model using learning policies optimized for each purpose, thereby constructing a high-performance vision inspection model that prevents performance degradation of a model due to mislabeled training data, maintains maximum recall on defective data, and improves precision for good product data.

In this connection, the vision inspection model training method and system thereof according to an embodiment of the present disclosure can detect noisy label data while stably training a model through the use of a warm-up training strategy, a mix-up technique, and an adaptation layer in a first stage process, and can perform learning to improve the classification performance of the model through supervised learning-based contrastive loss and cross entropy loss using the refined data as described above in a second stage process.

In other words, the vision inspection model training method and system thereof according to an embodiment of the present disclosure can provide a high-performance vision inspection model trained by minimizing the influence of noisy label data and maximizing the strength of contrastive learning by implementing an optimized learning policy for each stage as described above.

Additional features of the inventive concepts will be set forth in the description which follows, and in part will be apparent from the description, or may be learned by practice of the inventive concepts.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 illustrates an example block diagram of a computing system implementing a 2-stage vision inspection model training service according to an embodiment of the present disclosure.

FIG. 2 illustrates an example block diagram of a computing device implementing a 2-stage vision inspection model training service according to an embodiment of the present disclosure.

FIG. 3 illustrates an example block diagram of another aspect of a computing device implementing a 2-stage vision inspection model training service according to an embodiment of the present disclosure.

FIG. 4 illustrates a flow diagram of a first stage training process according to an embodiment of the present disclosure. FIG. 5 illustrates an example of an internal block diagram of a vision inspection model according to an embodiment of the present disclosure.

FIG. 6 illustrates an example showing changes in logit values as a function of training epochs according to an embodiment of the present disclosure.

FIG. 7 illustrates a block flow diagram of a warm-up training framework of a first stage training process according to an embodiment of the present disclosure.

FIG. 8 illustrates a block flow diagram of a model training framework after performing warm-up training according to an embodiment of the present disclosure.

FIG. 9 illustrates a conceptual diagram of a method for extracting a random clean set according to an embodiment of the present disclosure.

FIG. 10 illustrates a flow diagram of a method for extracting a random clean set according to an embodiment of the present disclosure.

FIG. 11 illustrates an example showing a method for selecting a clean set sample according to an embodiment of the present disclosure.

FIG. 12 illustrates a flow diagram of a second stage training process according to an embodiment of the present disclosure.

FIG. 13 illustrates a block flow diagram of a warm-up training framework of a second stage training process according to an embodiment of the present disclosure.

### DETAILED DESCRIPTION

The need in the art for better accuracy in computer-automated visual inspection of manufactured parts is addressed by the present disclosure. An exemplary system and method for implementing a 2-stage vision inspection model training service, which separately trains a first stage process for detecting noisy label data and a second stage process for training a classification model using learning policies optimized for each purpose, in order to efficiently learn a data set containing noisy labels meets this need and is described in detail hereinafter with reference to the attached drawings.

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As is customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Embodiments can impose various transformations that can have various embodiments, and Specific embodiments illustrated in the drawings will be described in detail in the detailed description. The advantages, features and methods for achieving the same will become apparent from the following description of the embodiments given in conjunction with the accompanying drawings. However, the present disclosure is not limited to the embodiments described herein but may be embodied in many different forms. It will be understood that, although the terms “first” or “second” may be used herein to distinguish one component from another component, these components should not be limited by these terms. In addition, a singular expression includes a plural expression, unless the context clearly states otherwise. In addition, it should be understood that the terms such as “include” or “have” are merely intended to indicate that features, or components described in the specification are present, and are not intended to exclude the possibility that one or more other features, or components will be added. In addition, components in the drawings may be exaggerated or shrunk for the convenience of descriptions. For example, since the size and thickness of each element in the drawings has been arbitrarily modified for the convenience of descriptions, it should be noted that the present disclosure is not necessarily limited to what has been shown in the drawings.

Hereinafter, embodiments of the present disclosure will be described in detail with reference to appended drawings. Throughout the specification, the same or corresponding component is assigned the same reference numeral, and repeated descriptions thereof will be omitted.

### [Exemplary System for Providing 2-Stage Vision Inspection Model Training Service]

Hereinafter, an exemplary system for implementing a 2-stage vision inspection model training service, which separately trains a 1-stage process for detecting noisy label data and a 2-stage process for training a classification model using learning policies optimized for each purpose, in order to efficiently learn a data set containing noisy labels is described in detail with reference to the attached drawings.

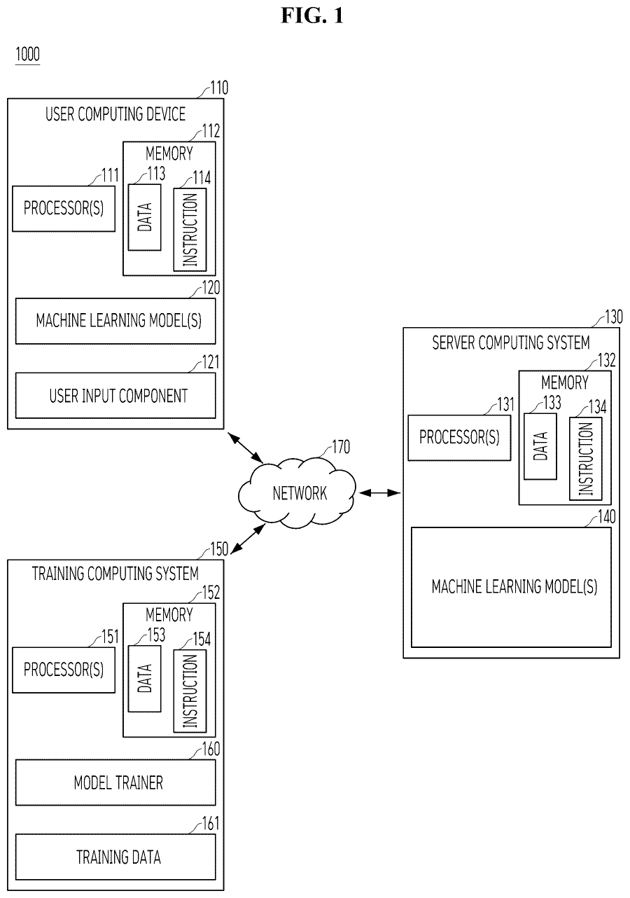

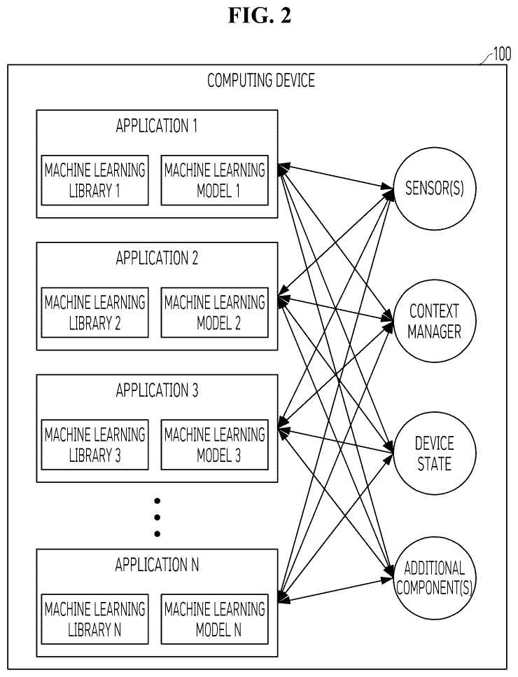

FIG. 1 illustrates an example block diagram of a computing system implementing a 2-stage vision inspection model training service according to an embodiment of the present disclosure.

Referring to FIG. 1, a computing system 1000 which implements the 2-stage vision inspection model training service according to an embodiment of the present disclosure includes a user computing device 110, a server computing system 130, and a training computing system 150, and any other devices which are configured to communicate through a network 170.

A vision inspection model training method according to an embodiment of the present disclosure May 1) be implemented and provided locally by the user computing device 110, 2) implemented and provided in the form of a web service by the server computing system 130 which communicates with the user computing device 110, and 3) implemented and provided by mutual association of the user computing device 110 and the server computing system 130.

In this connection, in an embodiment, the user computing device 110 and/or the server computing system 130 may train a machine learning model 120 and/or 140 through interaction with the training computing system 150, which communicates with either user computing device 110 or server computing system 130 communicationally connected through the network 170. The training computing system 150 may be a system separated from the server computing system 130 or may be a portion of the server computing system 130.

In addition, in this connection, the artificial intelligence model may be 1) directly trained locally by the user computing device 110, 2) trained while the server computing system 130 and the user computing device 110 interact with each other through the network 170, and 3) trained by using various training techniques and learning techniques by the separate training computing system 150. In addition, the method may also be implemented by a method in which the artificial intelligence model trained by the training computing system 150 is transmitted to the user computing device 110 and/or the server computing system 130 through the network 170, and is provided and updated.

In some embodiments, the training computing system 150 may be a portion of the server computing system 130 or a portion of the user computing device 110.

The user computing device 110 may include various types of computing devices such as a smart phone, a cellular phone, a digital broadcasting device, personal digital assistants (PDA), a portable multimedia player (PMP), a desktop, a wearable device, an embedded computing device, and/or a tablet PC.

The user computing device 110 includes at least one processor 111 and a memory 112. Herein, the processor 110 may be configured of at least one or a plurality of processors electrically connected among a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units for performing functions.

The memory 112 may include one or more non-transitory/transitory computer-readable storage media, such as RAM, ROM, EEPROM, EPROM, flash memory devices, or magnetic disks, and combinations thereof, and may include web storage of servers performing storage functions of the memory on the Internet. The memory 112 may store data 113 and instructions 114 necessary for the at least one processor 111 to perform a functional operation, such as training the artificial intelligence model or executing vision inspection through the artificial intelligence model.

In an embodiment, the user computing device 110 may store at least one machine learning model 120.

Specifically, the user computing device 110 may be various machine learning models such as a plurality of neural networks (for example, deep neural networks) or other types of machine learning models, including non-linear models and/or linear models, and may be configured of a combination thereof.

In this connection, the neural network may include at least one of feed-forward neural networks, recurrent neural networks (for example, long short-term memory recurrent neural networks), convolutional neural networks and/or other forms of neural networks.

In an embodiment, the user computing device 110 may receive at least one machine learning model 120 from the server computing system 130 via the network 170, store the same in the memory 112, and then execute the stored machine learning model 120 by the processor 111 to perform the vision inspection.

In another embodiment, the server computing system 130 may include at least one machine learning model 140 and perform operations through the machine learning model 140, and may provide the 2-second stage vision inspection model training service to a user by linking with the user computing device 110 in a manner of communicating data related thereto with the user computing device 110.

For example, the user computing device 110 may perform the 2-second stage vision inspection model training service by providing an output for the input of a user using the machine learning model 140 through the server computing system 130 via the web.

In addition, the artificial intelligence model may also be implemented in such a way that at least some of the machine learning models 120 and/or 140 are executed on the user computing device 110 and the rest are executed on the server computing system 130.

In addition, the user computing device 110 may include at least one input component 121 that detects user input. For example, the user input component 121 may include a touch sensor (for example, a touch screen and/or a touch pad) that detects touch of an input medium of a user (for example, a finger or a stylus), an image sensor that detects a motion input of a user, a microphone, a button, a mouse and/or a keyboard that detects user voice input. In addition, the user input component 121 may include an interface and an external controller when receiving input from an external controller (for example, a mouse or a keyboard) through the interface.

The server computing system 130 includes at least one processor 131 and a memory 132. Herein, the processor 131 may be configured of at least one or a plurality of processors electrically connected among a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units for performing functions.

In addition, the memory 132 may include one or more non-transitory/transitory computer-readable storage media, such as random access memory (RAM), read only memory (ROM), electrically erasable programmable read only memory (EEPROM), erasable programmable read only memory (EPROM), flash memory devices, or magnetic disks, and combinations thereof. The memory 132 may store data 133 and instructions 134 required for the processors 131 to perform a functional operation such as the train of the artificial intelligence model or the execution of the vision inspection through the artificial intelligence model.

In an embodiment, the server computing system 130 may be implemented to include one or more computing devices or computers. For example, the server computing system 130 may be implemented so that a plurality of computing devices operate according to sequential computing architecture, parallel computing architecture, or a combination thereof. Further, the server computing system 130 may include a plurality of computing devices connected through the network 170.

Further, the server computing device 130 may store one or more machine learning models 140. For example, the server computing system 130 may include a neural network and/or multilayer non-linear model as the machine learning model 140. An exemplary neural network may include a feed-forward neural network, a deep neural network, a recurrent neural network, and a convolution neural network.

The training computing system 150 includes at least one processor 151 and a memory 152. Herein, the processor 151 may be configured of at least one or a plurality of processors electrically connected among the CPU, the GPU, the ASICs, the DSPs, the DSPDs, the PLDs, the FPGAs, controllers, micro-controllers, microprocessors, and/or other electrical units for performing functions.

In addition, the memory 152 may include one or more non-transitory/transitory computer-readable storage media, such as RAM, ROM, EEPROM, EPROM, flash memory devices, or magnetic disks, and combinations thereof, and may include web storage of servers performing storage functions of the memory on the Internet. The memory 152 may store data 153 and instructions 154 necessary for the processor 151 to perform training of the artificial intelligence model.

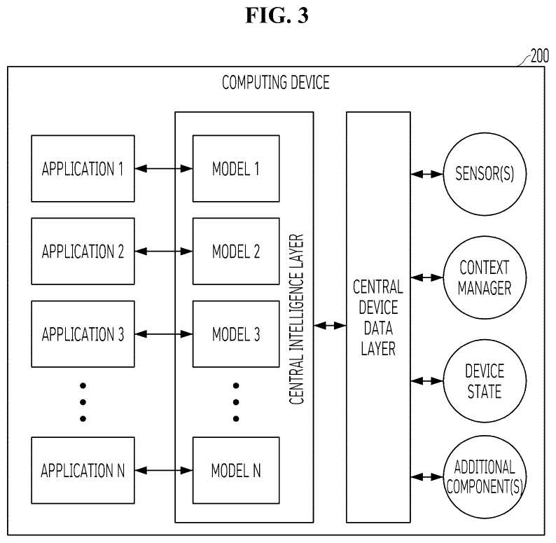

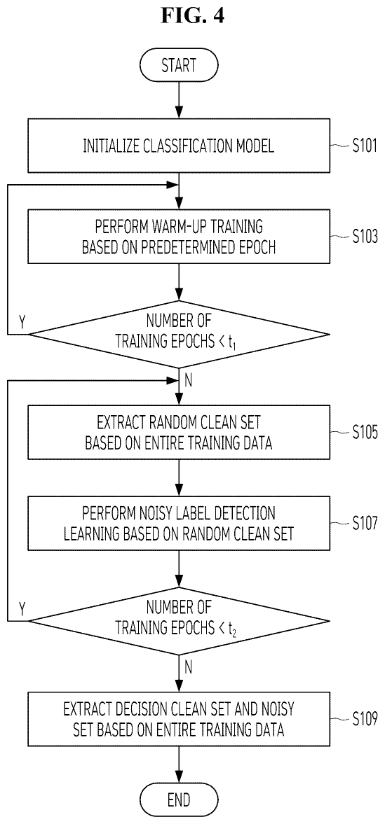

For example, the training computing system 150 may include a model trainer 160 configured to train the machine learning models 120 and/or 140 stored in the user computing device 110 and/or the server computing system 130 by using various training or learning techniques such as backpropagation of an error (according to the framework illustrated in FIG. 3).

For example, the model trainer 160 may perform an updating of one or more parameters of the machine learning models 120 and/or 140 based on a defined loss function by a backpropagation scheme.

In some implementation examples, the performance of the backpropagation of the error may include performing truncated backpropagation through time. The model trainer 160 may perform multiple generalization techniques (for example, weight reduction, drop-out, and/or knowledge distillation) in order to enhance a generalization capability of the trained machine learning models 120 and/or 140.

In particular, the model trainer 160 may train the machine learning models 120 and/or 140 based on a series of training data 161. Herein, the training data 161 may include, for example, different formats of data such as an image, an audio, and/or text. Examples of image type data which may be used may include a video frame, a LiDAR point cloud, an X-ray image, a computer tomography scan, a hyperspectral image, and/or various other types of images.

The training data 161 may be provided by the user computing device 110 and/or the server computing system 130. When the training computing device 150 trains the machine learning models 120 and/or 140 with respect to specific data of the user computing device 110, the machine learning models 120 and/or 140 may be characterized as a personalized model.

In addition, the model trainer 160 includes a computer logic utilized to provide a desired function.

Further, the model trainer 160 may be implemented as hardware, firmware, and/or software controlling a universal processor. In one implementation example, the model trainer 160 may include a program file stored in a storage device, and may be loaded to the memory 152 and executed by one or more processors 151. In another implementation example, the model trainer 160 includes one or more sets of computer-executable data 153 and instructions 154 stored in executable by a tangible computer-readable storage medium such as a RAM hard disk or an optical or magnetic medium.

The network 170 includes a 3rd Generation Partnership Project (3GPP) network, a Long Term Evolution (LTE) network, a World Interoperability for Microwave Access (WIMAX) network, Internet, a Local Area Network (LAN), Wireless Local Area Network (LAN), a Wide Area Network (WAN), a Personal Area Network (PAN), a Bluetooth network, a satellite broadcasting network, an analog broadcasting network, and/or a Digital Multimedia Broadcasting (DMB) network, but is not limited thereto.

In general, communication through the network 170 may be performed through various communication protocols (for example, TCP/IP, HTTP, SMTP, and/or FTP), encoding or formats (for example, HTML and/or XML), and/or protective schemas (for example, VPN, secure HTTP, and/or SSL) by using any type of wired and/or wireless communication.

FIG. 2 illustrates an example block diagram of a computing device implementing a 2-stage vision inspection model training service according to an embodiment of the present disclosure.

Referring to FIG. 2, the computing device 100 included in the user computing device 110, the server computing system 130, and the training computing system 150 include a plurality of applications (for example, application 1 to application N). Each application may include a machine learning library and at least one machine learning model. For example, the applications may include an image processing (for example, detection, classification and/or segmentation) application, a text messaging application, an e-mail application, a dictation application, a virtual keyboard application, a browser application, and a chat-bot application.

In an embodiment, the computing device 100 may include the model trainer 160 for training the artificial intelligence model, and may store and operate the trained artificial intelligence model to provide output data according to predetermined input data (in an embodiment, a predetermined image).

Each application of the computing device 100 may communicate with a number of other components of the computing device, such as, for example, one or more sensors, a context manager, a device state component, and/or additional components. In an embodiment, each application may communicate with each device component using an application programming interface (API, for example, a public API). In an embodiment, the API used by each application may be specific to the relevant application.

FIG. 3 illustrates an example block diagram of another aspect of a computing device 100 implementing a 2-stage vision inspection model training service according to an embodiment of the present disclosure.

Referring to FIG. 3, a computing device 200 includes a plurality of applications (for example, application 1 to application N). Each application is in communication with a central intelligence layer. For example, the applications may include an image processing application, a text messaging application, an e-mail application, a dictation application, a virtual keyboard application, and a browser application. In an embodiment, each application may communicate with the central intelligence layer (and model(s) stored therein) using an API (for example, a common API across all applications).

In addition, the central intelligence layer may include a plurality of machine learning models. For example, as illustrated in FIG. 3, a respective machine learning model and at least some additional machine learning models may be provided for each application and managed by the central intelligence layer. In other implementations, two or more applications may share a single machine learning model. For example, in some implementations, the central intelligence layer may provide a single model for all of the applications. In some implementations, the central intelligence layer may be included within an operating system of the computing device 200 or may be implemented differently.

The central intelligence layer may communicate with a central device data layer. The central device data layer may be centralized data storage for the computing device 200. As illustrated in FIG. 3, the central device data layer may communicate with a number of other components of the computing device 200, such as, for example, one or more sensors, a context manager, a device state component, and/or additional components. In some implementations, the central device data layer may communicate with each device component using an API (for example, a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein may be implemented using a single device or component or a plurality of devices or components working in combination. Databases and applications may be implemented on a single system or distributed across a plurality of systems. Distributed components may operate sequentially or in parallel.

### Method for Providing 2-Stage Vision Inspection Model Training Service

Hereinafter, a method for the computing system 1000 according to an embodiment of the present disclosure to implement a 2-stage vision inspection model training service, which separately trains a first stage process for detecting noisy label data and a second stage process for training a classification model using learning policies optimized for each purpose, in order to efficiently learn a data set containing noisy labels is described in detail.

Herein, a vision inspection model (VIM) according to an embodiment of the present disclosure may refer to an image deep learning model that performs anomaly detection based on a predetermined input image and classifies and/or recognizes the image based on the predetermined image.

For reference, the anomaly detection may refer to a process of identifying abnormal patterns, outliers, and/or exceptions from specific data.

In other words, the anomaly detection may be a process of detecting components that deviate from the attributes of normal data.

In an embodiment, the anomaly detection may be implemented based on a method such as grouping predetermined data into clusters and considering points that deviate from the clusters as outliers.

Accordingly, in an embodiment, the VIM may determine whether a predetermined input image contains a specific abnormal attribute, and classify and/or recognize the image based on the determination result.

Returning to the above, the 2-stage VIM training method of the computing system 1000 according to an embodiment of the present disclosure may conduct training by separating the first stage process for detecting the noisy label data from the data set used for training the VIM as described above and the second stage process for training the corresponding VIM using learning policies optimized for each purpose.

In other words, the 2-stage VIM training method of the computing system 1000 according to an embodiment of the present disclosure may use different learning policies for each stage through a 2-stage approach method that separates a noisy label data detection stage and a high-performance classification model (in an embodiment, the VIM) training stage.

For reference, detection of noisy label data that is mislabeled as ground truth is advantageous when selecting noisy labels through the distribution of ground truth labels within clusters with similar feature patterns within a widely distributed feature pattern space centered on image texture. However, this learning policy for detecting noisy label data degrades the performance of classification model training, which learns feature patterns centered on ground truth labels to better distinguish classes.

The 2-stage VIM training method of the computing system 1000 according to an embodiment of the present disclosure may address the aforementioned issues of conventional training methods that integrate noisy label detection and classification training by performing training optimized for the purpose of each stage.

Furthermore, the 2-stage VIM training method of the computing system 1000 according to an embodiment of the present disclosure utilizes the principle of contrastive learning within the noisy label detection process so as to implement learning that also considers feature differences from other samples, thereby securing the diversity of feature patterns extracted from the process and more accurately detecting cluster samples with similar features.

For reference, the contrastive learning refers to a learning method that pulls similar image samples closer together in a feature space and pushes dissimilar image samples further apart.

The contrastive learning using supervised learning utilizes class information to ensure that feature vectors within the same class are brought closer together in the feature space while moving feature vectors between different classes further apart, thus improving discriminability between classes.

This learning method not only improves classification accuracy but also includes robust learning against various variations to input, and thus is a learning method that is strong in tasks such as industrial defect detection that requires high precision.

By combining contrastive learning and classification learning, improved judgment accuracy may be achieved compared to using only the existing cross entropy loss-based classification learning.

However, the noisy label data not only significantly reduces the effectiveness of this contrastive learning, but also acts as a factor that hinders the learning during classification learning, lowering overall classification performance.

Accordingly, the 2-stage VIM training method of the computing system 1000 according to an embodiment of the present disclosure provides the aforementioned second stage VIM learning service, thereby reducing the influence of noisy label data and implementing VIM learning that leverages the strengths of contrastive learning described above.

Furthermore, the 2-stage VIM training method of the computing system 1000 according to an embodiment of the present disclosure may separate a data set that does not include noisy labels (hereinafter, “clean set”) and a data set that includes noisy labels (hereinafter, “noisy set”) within the VIM training process and use the same according to different learning policies.

In this connection, the 2-stage VIM training method of the computing system 1000 according to an embodiment of the present disclosure utilizes the principle of contrastive learning within the VIM training process, thereby improving precision for good product data while maintaining maximum recall for defective data.

Hereinafter, a method for performing the first stage process of detecting noisy label data and a method for performing the second stage process of training a classification model by the computing system 1000 according to an embodiment of the present disclosure will be described in detail separately.

### First Stage: Noisy Label Data Detection Process

In an embodiment of the present disclosure, the computing system 1000 may perform warm-up training using cross entropy loss for a predetermined number of epochs based on the entire training data set.

In addition, in an embodiment of the present disclosure, after performing warm-up training, the computing system 1000 may perform training using cross entropy loss and contrastive loss to induce similar samples to concentrate in one cluster and different samples to be separated from each other.

Furthermore, in an embodiment of the present disclosure, the computing system 1000 may evaluate the presence of noisy labels in the entire training data at the end of each epoch and update the clean set to be used for training in the next epoch.

In this connection, in an embodiment of the present disclosure, the computing system 1000 may utilize a Mixup technique to more robustly train the VIM.

For reference, Mixup is a data augmentation technique that helps calibrate a network during a learning stage by mixing two samples and assigning the calibrated label of an intermediate stage, and may reduce the influence of noisy label samples or ambiguous samples.

In an embodiment of the present disclosure, the computing system 1000 may filter noisy label data from the entire training data set through the first stage training process described above, and may implement a high-performance classification model (in an embodiment, the VIM) that excludes the influence of noisy label data by performing a second stage training process as described below based on the clean set and the noisy set evaluated in the final epoch.

In the following description, the classification model is described based on the VIM according to an embodiment of the present disclosure, but is not limited thereto.

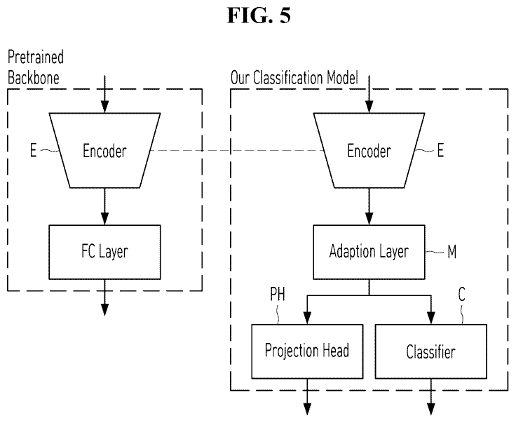

FIG. 4 illustrates flow diagrams of a first stage training process according to an embodiment of the present disclosure.

In detail, referring to FIG. 4, the computing system 1000 according to an embodiment of the present disclosure may include: initializing a classification model (S101); performing warm-up training based on a predetermined epoch (S103); extracting a random clean set based on the entire training data (S105); performing noisy label detection learning based on the random clean set (S107); and extracting a decision clean set and noisy set based on the entire training data (S109).

More specifically, in an embodiment, the computing system 1000 may initialize the classification model (S101).

In other words, in an embodiment, the computing system 1000 may initialize the VIM according to an embodiment of the present disclosure.

FIG. 5 illustrates an example of an internal block diagram of the VIM according to an embodiment of the present disclosure.

Herein, referring to FIG. 5, the VIM for classifying a predetermined defect may include at least one encoder E, at least one adaptation layer M, at least one projection head PH, and at least one classifier C.

In this connection, in an embodiment, the encoder E for extracting features from a given input image may be initialized to an arbitrary value and trained from the beginning with industrial vision inspection data. In addition, the encoder E of a backbone network pre-trained on a large dataset, such as ImageNet, may be used to utilize the rich image feature expression capability from the early stage of learning.

In other words, in an embodiment, the VIM may be implemented using the encoder E of a pre-trained backbone network, as illustrated in FIG. 5. In this connection, the backbone network may be based on various architectural structures, including ResNet and/or ConvNeXt.

The adaptation layer M, projection head PH, and classifier C described in an embodiment are configured of a fully connected layer and may be implemented as a single linear layer or a multi-layer perceptron.

In this connection, the projection head PH according to an embodiment may project an output of the adaptation layer M into a low-dimensional space to calculate contrastive loss.

Furthermore, the classifier C according to an embodiment may perform learning for the purpose of distinguishing classes of vision inspection data.

In an embodiment, the projection head PH described above is used only during the learning stage. During inference, a network configured of a trained encoder E, adaptation layer M, and classifier C, excluding the projection head PH, may classify the classes of predetermined vision inspection data.

In addition, in an embodiment, the computing system 1000 may perform warm-up training based on a predetermined epoch (S103).

In detail, in an embodiment, the computing system 1000 may perform warm-up training to train the VIM using cross entropy loss based on the entire training data set.

In this connection, in an embodiment, the computing system 1000 may execute the aforementioned warm-up training for a preset number of epochs (hereinafter, “warm-up training epoch threshold”) for warm-up training.

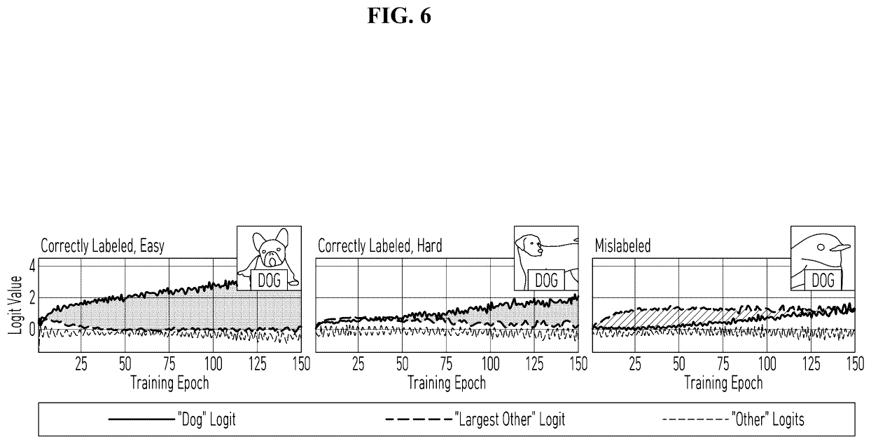

FIG. 6 illustrates an example showing changes in logit values according to training epochs according to an embodiment of the present disclosure.

Referring to FIG. 6, clean data samples that are generally easy to classify tend to first perform learning converge early, while data samples that are difficult to classify, such as data containing noisy labels, tend to perform learning converge later.

Accordingly, even when training is performed on the entire training data without classifying noisy labels in the initial training stage, learning convergence occurs on relatively accurately labeled, easy samples, thereby minimizing the influence of noisy label data within a small number of epochs.

In an embodiment, through this warm-up training, the computing system 1000 may construct an initial model for classifying noisy labels.

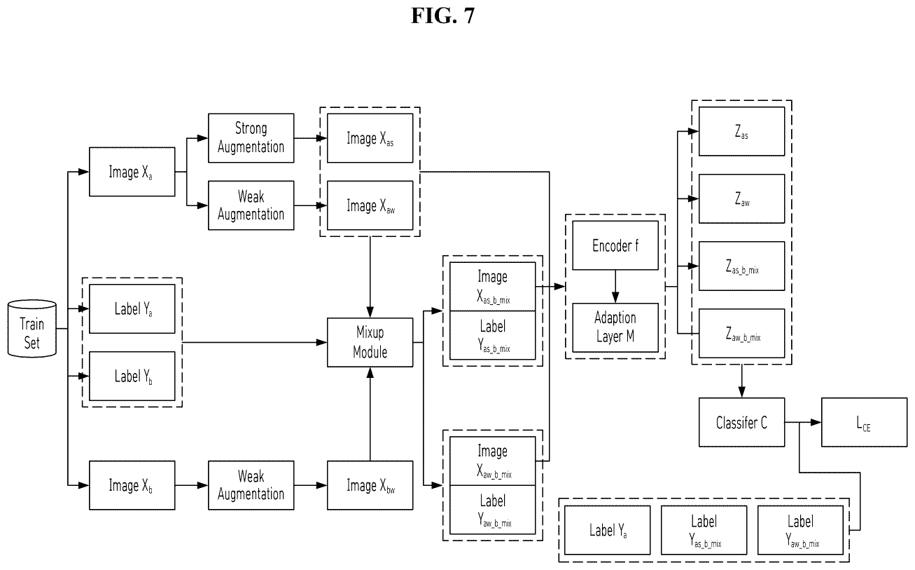

FIG. 7 illustrates a block flow diagram of a warm-up training framework of a first stage training process according to an embodiment of the present disclosure.

Referring to FIG. 7, which describes an embodiment of the present disclosure, data processing, input/output processing of each network, and loss function processing during the warm-up training performed in the first stage training process may be checked.

More specifically, according to FIG. 7, in an embodiment, the computing system 1000 may extract a predetermined data pair from the entire training data or a batch-wise training data.

Furthermore, in an embodiment, the computing system 1000 may perform data augmentation based on the extracted data pair to reflect various variations that may occur in a real-world environment.

In an embodiment, the computing system 1000 may perform strong variation augmentation, which relatively significantly changes an image, such as through random cropping, rotation, color jitter, and/or adding noise.

Furthermore, in an embodiment, the computing system 1000 may perform weak variation augmentation, which relatively slightly changes an image, such as through horizontal flipping, small rotations, and/or translations.

Furthermore, in an embodiment, the computing system 1000 may perform the aforementioned warm-up training based on the augmented training data.

In this connection, in an embodiment, the computing system 1000 may perform warm-up training based on the augmented training data using the Mixup technique.

Herein, in other words, the Mixup may be a technique that mixes two samples and assigns the calibrated label of an intermediate stage, which may support more stable learning performance by alleviating the influence of noisy label samples.

In an embodiment, the computing system 1000 may perform the Mixup according to the following [Equation 1] based on a predetermined first weakly varied training data sample and a second weakly varied training data sample, and a predetermined first weakly varied training data sample and a first strongly varied training data sample.

$${x}_{a \_ b \_ mix} = α {x}_{a} + ( 1 - α ) {x}_{b} \qquad [ Equation 1 ]$$

$${y}_{a \_ b \_ mix} = α {y}_{a} + ( 1 - α ) {y}_{b}$$

In this connection, in [Equation 1], “xa” and “xb” may represent images, and “ya” and “yb” may represent labels of the corresponding images.

In addition, in an embodiment, the computing system 1000 may input the strongly varied augmented image (xas) and the two mixed-up processed images (xas_b_mix, xaw_b_mix) into a network configured of the aforementioned encoder E, adaptation layer M, and classifier C, and acquire output values (pas, pas_b_mix, paw_b_mix).

In addition, in an embodiment, the computing system 1000 may perform network learning (in other words, warm-up training) by calculating the cross entropy loss according to the following [Equation 2] based on the acquired output values (pas, pas_b_mix, paw_b_mix) and the labels (yas, yas_b_mix, yaw_b_mix) of the corresponding images.

$${z}_{i} = M ( E ( {x}_{i} ) ) \qquad [ Equation 2 ]$$

$${p}_{i} = C ( {z}_{i} )$$

$${L}_{CE} = - {\sum }_{i - 1}^{n} {y}_{i} log ( {p}_{i} )$$

Here, in [Equation 2], “E” may represent the encoder E, “M” may represent the adaptation layer M, “C” may represent a classifier C network, “zi” may represent the feature vector of image “xi,” and “pi” may represent a predicted confidence value.

In this connection, in an embodiment, the computing system 1000 may perform learning by gradually increasing the learning rate from a minimum value to a preset predefined value during warm-up training.

Accordingly, the computing system 1000 may implement a stable learning environment that may adapt to new data sets while avoiding abrupt changes that might lead to poor learning convergence or overfitting.

Through the above warm-up training, in an embodiment, the computing system 1000 may acquire an initial VIM (in other words, an initial classification model) for classifying noisy labels.

In this connection, in an embodiment, the computing system 1000 may continue the warm-up training described above when the number of epochs of the performed warm-up training is less than a preset warm-up training epoch threshold t1.

In an embodiment, the computing system 1000 may complete the warm-up training when the number of epochs of the performed warm-up training is greater than or equal to the preset warm-up training epoch threshold t1.

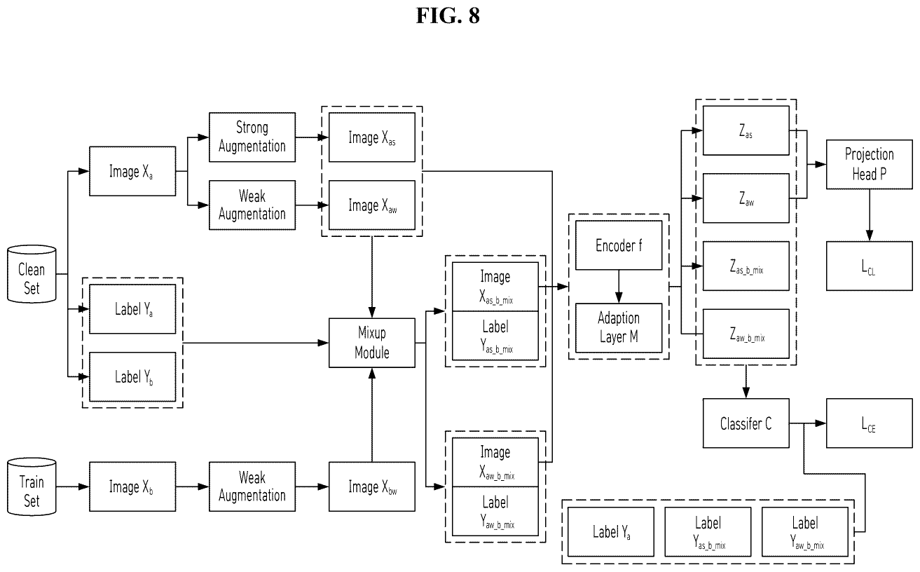

FIG. 8 illustrates a block flow diagram of a model training framework after performing warm-up training according to an embodiment of the present disclosure.

Accordingly, in an embodiment, the computing system 1000 may acquire an initial VIM (in other words, an initial classification model) having the training framework illustrated in FIG. 8.

Furthermore, in an embodiment, the computing system 1000 may extract the random clean set based on the entire set of training data (S105).

Herein, the term “random clean set” according to an embodiment may refer to the clean set (in other words, a data set that does not include noisy labels) for training the VIM in the first stage training process.

In detail, in an embodiment, the computing system 1000 may extract the aforementioned random clean set by determining the noisy labels for the entire training data after warm-up training is completed.

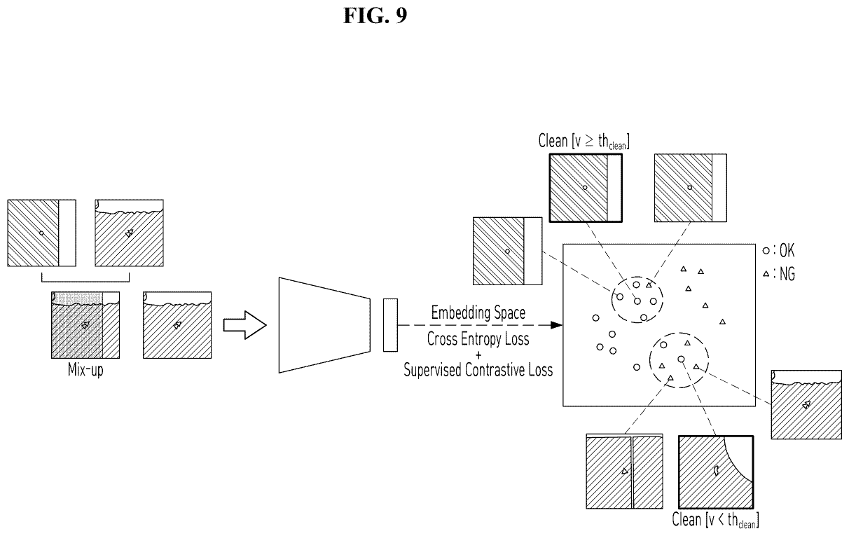

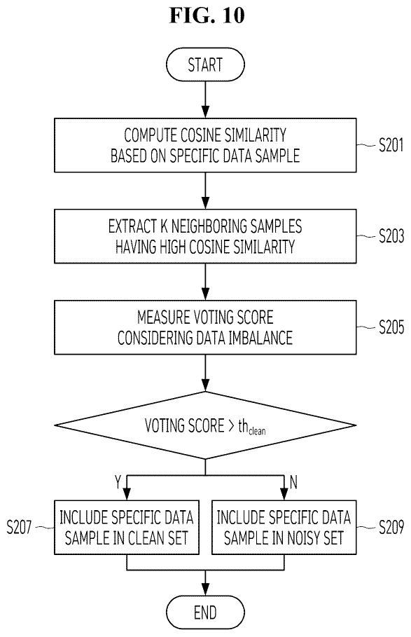

FIG. 9 illustrates a conceptual diagram of a method for extracting a random clean set according to an embodiment of the present disclosure. FIG. 10 illustrates a flow diagram of a method for extracting a random clean set according to an embodiment of the present disclosure.

More specifically, referring to FIGS. 9 and 10, in an embodiment, the computing system 1000 may extract the random clean set by predicting noisy label data based on a k-nearest neighbor (k-NN) algorithm.

For reference, k-NN may be an algorithm that detects the k nearest neighboring data around a given data point and predicts the label of the data point based on the information of the detected neighboring data.

Specifically, in an embodiment, the computing system 1000 may detect k neighboring (k-nearest neighbors) samples with the most similar extracted features based on the entire training data, based on a trained VIM, vote on a label (ground truth label) defined as true for supervised learning for the detected k neighboring samples, and calculate a score based on the votes to predict whether the entire training data contains noisy labels.

In other words, in an embodiment, the computing system 1000 may determine the aforementioned noisy label based on the characteristic that samples with similar features are more likely to have the same label, while other samples are more likely to be defined as mislabels.

In this connection, in an embodiment, the computing system 1000 may initially extract the random clean set based on the k-NN algorithm using the VIM trained in a warm-up training stage, and thereafter, extract the random clean set based on the k-NN algorithm at the end of each epoch using the VIM trained through stage S107 described below.

Referring further to FIG. 10, as an embodiment, the computing system 1000 may include: computing cosine similarity based on a specific data sample (S201); extracting k neighboring samples having high computed cosine similarity (S203); measuring a voting score considering data imbalance (S205); and including the specific data sample in the clean set (in other words, the random clean set) or a noisy set based on the measured voting score (S207, S209).

In detail, in an embodiment, the computing system 1000 may compute the cosine similarity according to the following [Equation 3] to measure feature similarity between specific data samples.

$$S ( {z}_{i ,} {z}_{j} ) = ( {z}_{i}^{T} {z}_{j} ) / ( {‖ {z}_{i} ‖}_{2} \cdot {‖ {z}_{j} ‖}_{2} \qquad [ Equation 3 ]$$

Herein, in [Equation 3], “zi” and “zj” may represent the feature vectors of the image as outputs of the encoder E and the adaptation layer M, as shown in [Equation 2].

In other words, in an embodiment, the computing system 1000 may predict whether a specific image sample ‘xi’ is a noisy label data by measuring a voting score based on the label defined as true in the k sample set ‘Ni’ with the highest cosine similarity.

However, the number of data samples for each class within the training data set is often not uniform. When the number of samples for each class is not considered, classes with a relatively large number of samples may have a higher probability of being included in the sample set ‘Ni’. In other words, classes with a relatively large number of samples are more likely to be incorrectly predicted as the clean set, while classes with a relatively small number of samples are more likely to be incorrectly predicted as a noisy set.

To alleviate the influence of this data imbalance issue, in an embodiment, the computing system 1000 may use weights that consider the number of data samples per class, as shown in [Equation 4] below.

$${ω}_{class} = [ 1 / {c}_{0 ,} 1 / {c}_{1 ,} … , 1 / {c}_{ℓ} ] \qquad [ Equation 4 ]$$

Herein, in [Equation 4], “cl” may represent the number of training data samples for the “1”-th class among the “L” classes to be classified in the training data set.

In this connection, in an embodiment, the computing system 1000 may compute label voting values for a set of k neighboring samples, “Ni,” considering the number of data samples per class, according to [Equation 5] below.

$$q = {ω}_{class} ∘ ( 1 / k ) {\sum }_{n ∈ N} \text{?} {y}_{n} , where {y}_{n} ∈ {\{ 0 , 1 \}}_{ℓ} \qquad [ Equation 5 ]$$

$$\text{?} \text{indicates text missing or illegible when filed}$$

Herein, in [Equation 5], “°” may represent a Hadamard Product.

Furthermore, in an embodiment, the computing system 1000 may compute the voting score for a specific image sample, “xi,” according to [Equation 6] below.

$${v}_{i} = ( {q}_{t} ) / ( {q}_{max} ) \qquad [ Equation 6 ]$$

Herein, in [Equation 6], each element value of q may represent a weighted sum of the number of neighboring samples of the “1”-th class, and “qmax” may represent the maximum value among the elements of “q.”

Furthermore, in [Equation 6], “qt” may represent the value of the “t”-th element among the elements of “q,” where “t” may be the class (ground truth label) of a specific image sample “xi.”

In other words, in an embodiment, the computing system 1000 may increase “vi” as the number of samples with the same label as a specific image sample “xi” within the neighboring sample set increases, and may set “vi” to “1” when the number of neighboring samples with the same label as a specific image sample is maximum.

As such, in an embodiment, the computing system 1000 may measure each voting score for all samples in the training data set after completing one epoch of learning.

In this connection, a higher voting score indicates that the same label has been assigned to image samples with similar features, which may indicate greater consistency in the labeling work.

In other words, in an embodiment, the computing system 1000 may consider a higher voting score as indicating a consistent label assignment, thereby determining the sample as a clean sample (in other words, a sample included in the clean set) rather than a noisy label sample.

Accordingly, in an embodiment, the computing system 1000 may compare the measured voting score with a preset threshold (thclean: hereinafter, “voting score threshold”).

In an embodiment, when the measured voting score exceeds the preset voting score threshold (thclean), the computing system 1000 may include the corresponding training data in the clean set (in other words, the random clean set).

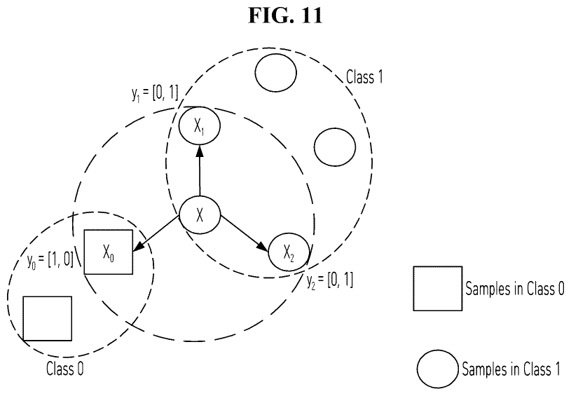

FIG. 11 illustrates an example showing a method for selecting a clean set sample according to an embodiment of the present disclosure.

FIG. 11, described in an embodiment of the present disclosure, shows an example of performing sample selection from a training data set that is a neighboring sample set and distinguishes two classes when “k=3.”

For example, referring to FIG. 11, the weight “ω_{class}” to alleviate the data imbalance issue is “[½, ⅕],” and “q” for a specific sample “X” is “[0.17, 0.13].” Since the specific sample “X” belongs to “class 1,” “qt” is “0.13” and “qmax” is “0.17.” Accordingly, the voting score for the specific sample “X” is “0.8,” and when the threshold “thclean” is defined as “0.7,” the specific sample “X” may be decided as the clean set.

In this connection, in an embodiment, when the predicted result of “pi” by the classifier C exceeds a specific threshold, the computing system 1000 determines that the result is highly reliable in the classification model (in other words, the VIM). Hence, according to the following [Equation 7], the label of the corresponding training data may be changed based on the predicted result of the classifier C.

$$\text{?} = \{ \begin{matrix}arg {max}_{p} \text{?} ( l ) , max {p}_{i} ( l ) > th \text{?} \\ l \text{?} , max p \text{?} ( l ) \leq {th}_{relabel}\end{matrix} \qquad [ Equation 7 ]$$

$$\text{?} \text{indicates text missing or illegible when filed}$$

In this connection, in an embodiment, the one-hot label vector “yi” of a specific sample image “xi” according to Equation 5 may match the class label “li” of “xi.”

Returning to the foregoing, in an embodiment, the computing system 1000 may extract the random clean set based on the entire training data according to the aforementioned process.

Furthermore, in an embodiment, the computing system 1000 may perform noisy label detection learning based on the random clean set (S107).

In detail, in an embodiment, the computing system 1000 may perform the noisy label detection learning based on the random clean set, sequentially following the model trained in stage S103 described above.

In other words, the computing system 1000 may perform the noisy label detection learning by training the VIM that has undergone the warm-up training based on the random clean set.

In this connection, in an embodiment, the computing system 1000 may perform the noisy label detection learning based on cross entropy loss and contrastive loss by dividing the entire training data set and the clean set (in other words, the random clean set) selected in stage S105 described above.

More specifically, the computing system 1000 may detect an original data set corresponding to the random clean set extracted as described above.

In other words, the computing system 1000 may detect the original data prior to performing Mixup processing on each training data included in the random clean set.

Furthermore, in an embodiment, the computing system 1000 may perform data augmentation based on the detected original data set.

In other words, the computing system 1000 may perform strong variation augmentation and/or weak variation augmentation using the original data set.

A detailed description thereof applies to the description described in stage S103 described above.

Accordingly, in an embodiment, the computing system 1000 may perform the noisy label detection learning described above based on the augmented training data.

In this connection, in an embodiment, the computing system 1000 may perform training for the encoder E, the adaptation layer M, and the classifier C in the same manner following the training results from stage S103 described above.

Furthermore, in an embodiment, the computing system 1000 may perform training for the projection head PH using a contrastive loss as shown in [Equation 8] below.

$$\text{?} \qquad [ Equation 8 ]$$

$$\text{?} \text{indicates text missing or illegible when filed}$$

Herein, in [Equation 8], “s” may represent the cosine similarity between the output vectors of the projection head PH, and ‘r’ may be a temperature scaling parameter for model calibration.

Accordingly, in an embodiment, the computing system 1000 may perform learning to induce variations derived from one sample image to have feature vectors of similar forms, while inducing the same to have feature vectors of different forms from other sample images within a batch.

Since noisy label data detection, as in stage S105 described above, involves selecting noisy labels through the distribution of correct labels within clusters with similar feature patterns centered on image features, it is important to minimize feature changes for variations of the same image while being well distinguished from other image samples.

In an embodiment of the present disclosure, the computing system 1000 may easily achieve the above purposes by performing learning using contrastive loss, as in [Equation 8].

In this connection, in an embodiment, the computing system 1000 may perform network learning using a loss function as shown in [Equation 9] below.

$${L}_{total} = {λ}_{CE} {L}_{CE} + {λ}_{CL} {L}_{CL} \qquad [ Equation 9 ]$$

In this connection, in [Equation 9], ˜CE″ and “λCI” may be hyperparameters that decide the weights of each loss function.

As such, in an embodiment, the computing system 1000 applies the principle of contrastive learning to the first stage training process for noisy label detection. Unlike conventional techniques that use a negative cosine similarity loss function to maintain feature consistency to induce similarity only in the feature distribution resulting from the variation of one sample without considering feature differences from other samples, the computing system 1000 implements learning that also considers feature differences from other samples, thereby securing the diversity of extracted feature patterns and enabling more accurate extraction of cluster samples with similar features.

In this connection, in an embodiment, when the number of epochs of noisy label detection learning performed is less than a preset noisy label detection training epoch threshold t2, the computing system 1000 may continue the aforementioned random clean set extraction and noisy label detection learning.

In an embodiment, when the number of epochs of noisy label detection learning performed is greater than or equal to the preset noisy label detection training epoch threshold t2, the computing system 1000 may complete the clean set extraction and noisy label detection learning.

Furthermore, in an embodiment, the computing system 1000 may extract a decision clean set and a noisy set based on the entire training data (S109).

Herein, the decision clean set according to an embodiment may refer to the clean set (in other words, a data set that does not include noisy labels) for the VIM learning in the second stage training process.

In other words, in an embodiment, the decision clean set may be the clean set finally classified and output from the VIM trained through the first stage training process.

Furthermore, a decision noisy set according to an embodiment may refer to a noisy set (in other words, a data set including noisy labels) for training the VIM in the second stage training process.

In other words, in an embodiment, the decision noisy set may be the noisy set finally classified and output from the VIM trained through the first stage training process.

In detail, in an embodiment, after the noisy label detection learning is completed, the computing system 1000 may extract the decision clean set and decision noisy set described above by determining whether the entire training data contains noisy labels.

In other words, the computing system 1000 may extract the decision clean set and decision noisy set based on the entire training data using the VIM for which noisy label detection learning has been completed.

In this connection, in an embodiment, the computing system 1000 distinguishes and extracts the clean set and the noisy set in the same manner as in stage S105 described above, and the detailed description thereof applies here as well.

Accordingly, in an embodiment, the computing system 1000 may acquire the decision clean set based on the extracted clean set and the decision noisy set based on the extracted noisy set.

As such, in an embodiment, the computing system 1000 performs warm-up training using cross entropy loss for a predetermined number of epochs based on the entire training data set, and after performing the warm-up training, performs noisy label detection learning using cross entropy loss and contrastive loss, thereby inducing similar samples to be concentrated in one cluster and different samples to be spaced apart from each other so as to evaluate the presence or absence of noisy labels for the entire training data at the end of each epoch and to update the clean set and/or noisy set to be used for training in the next epoch.

Thus, the computing system 1000 may acquire the clean set and the noisy set, filtered with high accuracy, from the entire training data set, and based thereon, perform the second stage training process as described below to construct a high-performance classification model (in an embodiment, the VIM) that significantly eliminates the influence of noisy label data.

### Second Stage: High-Performance Classification Model Training Process

Next, in an embodiment of the present disclosure, the computing system 1000 may perform a training process (in other words, the 2-stage process) to enhance the performance of the classification model (in other words, the VIM) based on the decision clean set and decision noisy set defined through the first stage process.

Specifically, in an embodiment, the computing system 1000 may perform learning based on cross entropy loss, contrastive loss, and supervised learning-based contrastive loss based on the decision clean set and decision noisy set acquired as described above.

In this connection, in an embodiment, the computing system 1000 may use the decision noisy set only for the purpose of learning feature patterns to utilize the raw information contained in the corresponding image sample.

In an embodiment of the present disclosure, when the first stage process has the purpose of detecting noisy label samples and distinguishing between clean and noisy sets, the second stage process may have the purpose of achieving optimized classification model performance for a vision inspection data set.

In other words, through the 2-stage process, the computing system 1000 may implement the VIM that improves precision for good product data while maintaining maximum recall for defective data, taking into account the characteristics of vision inspection, where preventing defect leakage is a critical factor.

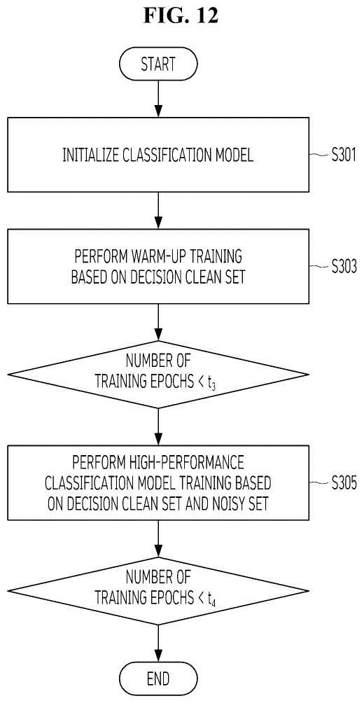

FIG. 12 illustrates a flow diagram of a second stage training process according to an embodiment of the present disclosure.

Specifically, referring to FIG. 12, the computing system 1000 according to an embodiment of the present disclosure may include: initializing a classification model (S301); performing warm-up training based on a decision clean set (S303); and performing high-performance classification model training based on the decision clean set and a decision noisy set (S305).

More specifically, in an embodiment, the computing system 1000 may initialize the classification model (S301).

Specifically, in an embodiment, the computing system 1000 may perform classification model initialization using a new VIM.

In other words, the computing system 1000 may perform the second stage process using the new VIM without using the model trained in the first stage process.

In this connection, in an embodiment, the computing system 1000 may perform the classification model (in other words, the VIM) initialization described above in the same manner as in stage S101.

Furthermore, in an embodiment, the computing system 1000 may perform the warm-up training based on the decision clean set (S303).

Specifically, in an embodiment, the computing system 1000 may perform the warm-up training to train the VIM using cross entropy loss based on the decision clean set defined through the first stage process.

Herein, the specific method by which the computing system 1000 performs the warm-up training in an embodiment of the present disclosure applies the description of stage S103 described above. Hereinafter, the differences from stage S103 will be primarily described.

As described above, data samples that are generally clear and easily classified tend to first learning converge early on. Accordingly, in the first stage process, training is performed for a preset small number of epochs to alleviate the influence of noisy label data. However, since the warm-up training is performed using the entire training data set, including noisy label samples, some influence of noisy labels may be present.

Accordingly, in the second stage process according to an embodiment of the present disclosure, the warm-up training is performed using the clean set (in other words, the decision clean set) selected in the first stage process to block the influence of noisy label samples.

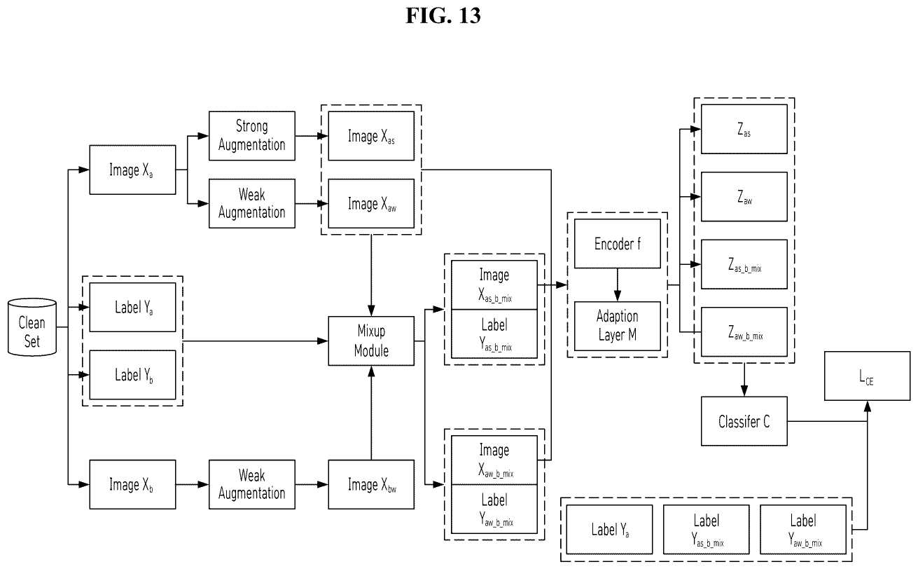

FIG. 13 illustrates a block flow diagram of a warm-up training framework of a second stage training process according to an embodiment of the present disclosure.

Referring to FIG. 13 as described in an embodiment of the present disclosure, data processing, and input/output and loss function processing process for each network during the warm-up training performed in the second stage training process may be checked.

According to FIG. 13, in an embodiment, the computing system 1000 may perform second stage warm-up training on the VIM using the strong variation augmentation, weak variation augmentation, and Mixup technique in the same manner as a warm-up training process of the first stage training process.

Herein, in other words, the Mixup supports effective network calibration during the learning stage by mixing two samples and assigning the calibrated level of an intermediate stage. Accordingly, when used in conjunction with oversampling for classes with a small number of samples, it may significantly alleviate data imbalance issues.

In this connection, in an embodiment, the computing system 1000 may perform decision clean set-based warm-up training using the cross entropy loss as in [Equation 2] described above.

Furthermore, in an embodiment, the computing system 1000 may continue the aforementioned warm-up training when the number of epochs of the performed warm-up training is less than a preset warm-up training epoch threshold t3.

In an embodiment, the computing system 1000 may complete the warm-up training when the number of epochs of the performed warm-up training is greater than or equal to the preset warm-up training epoch threshold t3.

As such, in an embodiment, the computing system 1000 may prevent the influence of noisy labels that may be included in the entire training data set by performing warm-up training in the second stage process using the clean set (in other words, the decision clean set) defined through the first stage process.

Furthermore, in an embodiment, the computing system 1000 may perform high-performance classification model training based on the decision clean set and the noisy set (S305).

In detail, in an embodiment, the computing system 1000 may perform high-performance classification model training based on the decision clean set and the decision noisy set, sequentially following the model trained in the aforementioned stage S303.

In other words, the computing system 1000 may perform high-performance classification model training by training the VIM for which the warm-up training has been performed based on the decision clean set and the decision noisy set.

Herein, in an embodiment, the computing system 1000 may perform training based on cross entropy loss, contrastive loss, and supervised learning-based contrastive loss by dividing (distinguishing) the decision clean set and the decision noisy set, as shown in FIG. 8.

More specifically, in an embodiment, the computing system 1000 may utilize the feature information contained in the noisy label data for high-performance classification model training using the contrastive loss, as described above in [Equation 8], based on the decision noisy set.

In other words, in an embodiment, the computing system 1000 performs feature information learning using contrastive loss for noisy label samples determined to have been assigned mislabeled information but for which the raw information contained in the corresponding image sample is desired to be utilized. This allows the computing system 1000 to exclude the noisy label information from learning and utilize only the feature information.

In an embodiment, the computing system 1000 may perform high-performance classification model training by concurrently using the cross entropy loss according to the aforementioned [Equation 2] and the supervised learning-based contrastive loss according to the following [Equation 10] based on the decision clean set.

$${L}_{supcon} = {\sum }_{i ∈ I} - ( 1 / \vert P ( i ) \vert ) {\sum }_{j ∈ P ( i )} log \{ exp ( {v}_{i} \cdot {v}_{j} / τ ) / {\sum }_{a ∈ A ( i )} exp ( {v}_{j} \cdot {v}_{a} / τ ) \} \qquad [ Equation 10 ]$$

Herein, “L_{supcon}” in [Equation 10] may be a hyperparameter that decides the weight of the loss function.

Furthermore, “P(i)” in [Equation 10] may represent a set of samples (positives) of the same class among the samples included in the batch, and “A(i)” may represent the entire sample set of the batch.

In addition “vi” in [Equation 10] may be the output vector of the projection head PH, and “r” may be a temperature scaling parameter for model calibration.

As such, in an embodiment, the computing system 1000 further performs supervised learning-based contrastive loss learning based on the decision clean set, thereby increasing the discriminability between classes by bringing feature vectors of the same class closer together in the feature space and moving feature vectors of different classes further apart.

Thus, the computing system 1000 may construct the VIM that not only improves classification accuracy but also operates robustly against various variations to input, thereby providing a classification model optimized for tasks such as defect detection that require high precision.

In this connection, in an embodiment, the computing system 1000 may perform network learning using a loss function such as [Equation 10] as above.

In this connection, in an embodiment, the computing system 1000 may continue performing high-performance classification model training as described above when the number of epochs of the performed high-performance classification model training is less than a preset high-performance classification model training epoch threshold t4.

In an embodiment, the computing system 1000 may complete high-performance classification model training when the number of epochs of the performed high-performance classification model training is greater than or equal to the preset high-performance classification model training epoch threshold t4.

Thus, the computing system 1000 according to an embodiment of the present disclosure may provide a classification model (in other words, the VIM) efficiently trained based on a data set containing noisy labels.

In an embodiment, the computing system 1000 may provide the VIM trained according to an embodiment based on a predetermined application service (for example, an outlier detection service).

As a more specific example, the computing system 1000 according to an embodiment of the present disclosure may provide various vision inspection services to users using the VIM trained according to the 2-stage training method described above, as described below.

In detail, the vision inspection service according to an embodiment of the present disclosure may be implemented through the computing system 1000 illustrated in FIG. 1 and provided through interaction between a user terminal (for example, the user computing device 110) and the server computing system 130.

More specifically, the server computing system 130 may first load or store a high-performance VIM trained as described above into the memory 132.

In this connection, the trained VIM may use the network configured of the trained encoder E, adaptation layer M, and classifier C, excluding the projection head PH, during an inference stage.

Next, a user may acquire an image of a target requiring vision inspection (for example, parts for industrial sites, or products) via the input component 121 (for example, a camera or image scanner) of the user computing device 110.

In this connection, the acquired inspection target image may be transmitted to the server computing system 130 via the network 170.

The server computing system 130 may then perform inference using the received inspection target image as input using a pre-stored VIM.

Specifically, the processor 131 passes the inspection target image through the encoder E and the adaptation layer M of the VIM to extract a feature vector of the image. Subsequently, the processor 131 may classify the image as normal (OK) or defective (NG) using the classifier C.

In this process, the VIM may generate accurate classification results based on maximum recall for defective data and high precision for good product data.

Once the inference is complete, the server computing system 130 may transmit the generated classification results (for example, “normal,” “defect,” type of defect, or confidence score) back to the user computing device 110 via the network 170.

Accordingly, the user computing device 110 may provide the received classification results to a user via an output component, such as a display device.

For example, the user computing device 110 may display the text “Defect Found” on the screen or visually highlight and display a location of the defect on the inspection target image (for example, a bounding box and/or heatmap).

Furthermore, the user computing device 110 may generate and transmit, to an external device, a signal that triggers follow-up actions, such as stopping the conveyor belt or automatically classifying defective products using a robotic arm, based on the classification results.

As such, in an embodiment of the present disclosure, by minimizing the influence of noisy label data, the trained high-performance VIM may be used to provide a highly reliable automated vision inspection service in an actual industrial site, thereby improving productivity and quality management.

As described above, the computing system 1000 according to an embodiment of the present disclosure may detect noisy label data while stably training the model through the use of a warm-up training strategy, a Mixup technique, and the adaptation layer M in the first stage process. Furthermore, in the second stage process, the classification performance of the model may be improved through supervised learning-based contrastive loss and cross entropy loss using the refined data as described above.

In other words, in an embodiment, the computing system 1000 uses a 2-stage approach method that separates the noisy label data detection stage from the high-performance classification model training stage, thereby preventing model performance degradation caused by mislabeled training data by using different customized learning policies for each stage.

In particular, in an embodiment, unlike existing technologies, the computing system 1000 concurrently performs contrastive loss-based learning, which does not use mislabeled information in the noisy label data set but uses the feature information contained in the data, thereby constructing and providing the VIM that maintains maximum recall for defective data while improving precision for good product data.

The embodiments of the present disclosure described above may be implemented in the form of program commands which may be executed through various types of computer constituting elements and recorded in a computer-readable recording medium. The computer-readable recording medium may include program commands, data files, and data structures separately or in combination thereof. The program commands recorded in the computer-readable recording medium may be those designed and configured specifically for the present disclosure or may be those commonly available for those skilled in the field of computer software. Examples of a computer-readable recoding medium may include magnetic media such as hard-disks, floppy disks, and magnetic tapes; optical media such as CD-ROMs and DVDs; and hardware devices specially designed to store and execute program commands such as ROM, RAM, and flash memory. Examples of program commands include not only machine codes such as those generated by a compiler but also high-level language codes which may be executed by a computer through an interpreter and the like. The hardware device may be replaced with by one or more software modules to perform the operations of the present disclosure, and vice versa.

Specific executions described in the present disclosure are exemplary embodiments and the scope of the present disclosure is not limited even by any method. For brevity of the specification, descriptions of conventional electronic configurations, control systems, software, and other functional aspects of the systems may be omitted. Further, connection or connection members of lines among components exemplarily represent functions connections and/or physical or circuitry connections and may be represented as various functional connections, physical connections, or circuitry connections which are replaceable or added in an actual device. Further, unless otherwise specified, such as “essential” or “important,” the connections may not be components particularly required for application of the present disclosure.

Further, in the detailed description of the present disclosure, which is described, while the present disclosure has been described with respect to the preferred embodiments, it will be understood by those skilled in the art or those skilled in the art having ordinary knowledge in the technical field that various changes and modifications of the present disclosure may be made without departing from the spirit and the technical scope of the invention described in the following claims. Accordingly, the technical scope of the present disclosure should not be limited to the contents described in the detailed description of the present disclosure but should be defined by the claims.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A visual inspection method, comprising:
providing a uniform group of manufactured products;
performing a first process for detecting noisy label data within a training data set;
acquiring a noisy data set and a clean data set according to the noisy label data detected based on the first process;
performing a second process for training a vision inspection model based on the acquired noisy data set and clean data set;
visually inspecting the products using the vision inspection model to identify defective products within the group; and
removing the defective products from the group.

2. The method of claim 1, wherein the vision inspection model comprises at least one encoder, at least one adaptation layer, at least one projection head, and at least one classifier.

3. The method of claim 2, wherein the performance of the first process comprises:
initializing the vision inspection model;
performing a first warm-up training to train the initialized vision inspection model for a predetermined number of epochs based on the training data set;
detecting the noisy label data within the training data set based on the vision inspection model trained with the first warm-up training;
acquiring a random clean data set according to the detected noisy label data;
performing noisy label detection learning to train the vision inspection model trained with the first warm-up training for a predetermined number of epochs based on the acquired random clean data set and the training data set;
detecting the noisy label data within the training data set based on the noisy label detection trained vision inspection model; and
acquiring the noisy data set and the clean data set according to the detected noisy label data.

4. The method of claim 3, wherein the performance of the first warm-up training comprises performing learning based on cross entropy loss.

5. The method of claim 4, wherein the performance of the first warm-up training further comprises:
extracting a predetermined data pair from the training data set;
performing data augmentation based on the extracted data pair; and
acquiring weak variation augmentation data, which is data with relatively small variations, and strong variation augmentation data, which is data with relatively large variations, based on the performed data augmentation.

6. The method of claim 5, wherein the performance of the first warm-up training further comprises acquiring first mix-up data, which is data obtained by mixing up first weak variation augmentation data and second weak variation augmentation data, and second mix-up data, which is data obtained by mixing up first weak variation augmentation data and first strong variation augmentation data.

7. The method of claim 6, wherein the performance of the first warm-up training further comprises performing learning according to the cross entropy loss based on the first mix-up data, the second mix-up data, and the first strong variation augmentation data.

8. The method of claim 3, wherein the detection of the noisy label data comprises:
computing cosine similarity between other training data based on first training data within the training data set;
extracting a predetermined number (k) of neighboring training data, which is other training data with high computed cosine similarity;
computing voting scores for each of the extracted neighboring training data; and
detecting the noisy label data based on the computed voting scores.

9. The method of claim 3, wherein the performance of the noisy label detection learning comprises:
training the projection head based on a first clean data set and a contrastive loss; and
training the encoder, the adaptation layer, and the classifier based on the training data set and a cross entropy loss.

10. The method of claim 3, wherein the performance of the noisy label detection learning comprises:
detecting an original data set corresponding to a first clean data set;
performing data augmentation based on the detected original data set; and
performing the noisy label detection learning based on the augmented data.

11. The method of claim 3, wherein the performance of the second process comprises:
newly initializing the vision inspection model;
performing a second warm-up training to train the newly initialized vision inspection model for a predetermined number of epochs based on the clean data set; and
performing a high-performance classification model training to train the vision inspection model trained with the second warm-up training for a predetermined number of epochs based on the clean data set and the noisy data set.

12. The method of claim 11, wherein the performance of the high-performance classification model training comprises:
performing learning according to concurrent use of cross entropy loss and supervised learning-based contrastive loss based on the clean data set; and
performing learning according to contrastive loss based on the noisy data set.

13. The method of claim 1, further comprising providing the vision inspection model trained based on the second process through a predetermined application service.

14. A computing system comprising a non-transitory memory and at least one processor, the memory including instructions to provide a vision inspection service using a multi-tasking model, the model being trained and implemented according to a method comprising:
providing a manufactured product;
receiving an inspection target image of the product from a user computing device;
performing a first process for detecting noisy label data within a training data set;
acquiring a noisy data set and a clean data set according to the noisy label data detected based on the first process;
performing a second process for training the multi-tasking model based on the acquired noisy data set and clean data set;
inputting the received inspection target image into the trained multi-tasking model to generate a classification result for the image; and
transmitting the generated classification result to the user computing device.

15. The computing system of claim 14, wherein the classification result comprises at least one of information indicating whether the inspection target image is normal or defective, information on a type of defect, or a confidence score.

16. The computing system of claim 15, wherein the user computing device visually highlights and displays a location of the defect on the inspection target image based on the transmitted classification result.

17. A computing device comprising:
at least one encoder;
at least one adaptation layer;
at least one projection head;
at least one classifier, and
at least one processor controlling the encoder, the adaptation layer, the projection head, and the classifier,
wherein the processor is configured to:
perform a first process for detecting noisy label data within a training data set;
acquire a noisy data set and a clean data set according to the noisy label data detected based on the first process; and
perform a second process for training a vision inspection model based on the acquired noisy data set and clean data set.
